(19) United States
(12) Patent Application Publication
(10) Pub. No.: US 2025/0184167 A1
(43) Pub. Date: Jun. 5, 2025

(54) COMMUNICATION METHOD

(71) Applicant: KYOCERA Corporation, Kyoto (JP)

(72) Inventors: Masato FUJISHIRO, Yokohama-shi (JP); Henry CHANG, San Diego, CA (US)

(73) Assignee: KYOCERA Corporation, Kyoto (JP)

(21) Appl. No.: 19/048,327

(22) Filed: Feb. 7, 2025

Related U.S. Application Data
(63) Continuation of application No. PCT/JP2023/028761, filed on Aug. 7, 2023.
(60) Provisional application No. 63/396,354, filed on Aug. 9, 2022.

(51) Int. Cl. H04L 12/18; H04W 76/27

(52) U.S. Cl. CPC H04L 12/18; H04W 76/27

(57) ABSTRACT

A communication method used in a mobile communication system that provides a multicast/broadcast service (MBS) includes receiving, by a user equipment, a multicast control channel (MCCH) from a network, the multicast control channel including a plurality of MBS configurations of a plurality of MBS sessions. The plurality of MBS configurations include a broadcast configuration for a broadcast session and a multicast configuration for a multicast session.

### RELATED APPLICATIONS

The present application is a continuation based on PCT Application No. PCT/JP2023/028761, filed on Aug. 7, 2023, which claims the benefit of U.S. Provisional Patent Application No. 63/396,354 filed on Aug. 9, 2022. The content of which is incorporated by reference herein in their entirety.

### TECHNICAL FIELD

The present disclosure relates to a communication method used in a mobile communication system.

### BACKGROUND

The 3rd Generation Partnership Project (3GPP) has defined the technical specifications of New Radio (NR) that is radio access technology of the fifth generation (5G). NR has features such as high speed, large capacity, high reliability, and low latency as compared to Long Term Evolution (LTE) that is a radio access technology of the fourth generation (4G). The 3GPP has defined technical specifications of multicast/broadcast services (MBS) of 5G/NR (for example, see Non-Patent Document 1).

### CITATION LIST

### Non-Patent Literature

Non-Patent Document 1: 3GPP Technical Specification: TS 38.300 V17.1.0

In a first aspect, a communication method used in a mobile communication system that provides a multicast/broadcast service (MBS) includes receiving, by a user equipment, a multicast control channel (MCCH) from a network, the multicast control channel including a plurality of MBS configurations of a plurality of MBS sessions. The plurality of MBS

### SUMMARY

configurations include a broadcast configuration for a broadcast session and a multicast configuration for a multicast session.

In a second aspect, a communication method used in a mobile communication system that provides a multicast/broadcast service (MBS) includes the steps of receiving, by a user equipment in a radio resource control (RRC) connected state, a multicast session from a network; and receiving, by the user equipment from the network, an RRC release message for causing the user equipment to transition to an RRC inactive state. The RRC release message includes an MBS configuration provided by the network on a multicast control channel (MCCH).

In a third aspect, a communication method used in a mobile communication system that provides a multicast/broadcast service (MBS) includes the steps of: receiving, by a user equipment in a radio resource control (RRC) connected state, a multicast session from a network; receiving, by the user equipment, a reception instruction for a multicast control channel (MCCH) from the network; attempting, by the user equipment, to receive the multicast session by receiving the MCCH in response to the reception instruction; and transmitting, by the user equipment to the network, information indicating the multicast session successfully or unsuccessfully received.

In a fourth aspect, a communication method used in a mobile communication system that provides a multicast/broadcast service (MBS) includes the steps of: receiving, by a user equipment in a radio resource control (RRC) connected state, a multicast session from a network by using an MBS configuration of the multicast session; transitioning the user equipment to an RRC inactive state; attempting, by the user equipment in the RRC inactive state, to receive a multicast control channel (MCCH); and continuing, by the user equipment in the RRC inactive state, receiving the multicast session by using the MBS configuration until the user equipment receives the MCCH.

In a fifth aspect, a communication method used in a mobile communication system that provides a multicast/broadcast service (MBS) includes the steps of: receiving, by a user equipment in a radio resource control (RRC) inactive state, a multicast session from a network by using a first MBS configuration provided on a multicast control channel (MCCH); transitioning the user equipment to an RRC connected state; receiving, by the user equipment in the RRC connected state, an RRC reconfiguration message including a second MBS configuration from the network; and discarding, by the user equipment in the RRC connected state, the first MBS configuration in response to the reception of the RRC reconfiguration message.

In a sixth aspect, a communication method used in a mobile communication system that provides a multicast/broadcast service (MBS) includes the steps of: receiving, by a user equipment in a radio resource control (RRC) inactive state, a multicast session from a network by using an MBS configuration provided on a multicast control channel (MCCH); transitioning the user equipment to an RRC idle state; and discarding, by the user equipment, the MBS configuration in response to the transition to the RRC idle state.

### BRIEF DESCRIPTION OF THE DRAWINGS

FIG. 1 is a diagram illustrating a configuration of a mobile communication system according to an embodiment.

FIG. 2 is a diagram illustrating a configuration of a user equipment (UE) according to an embodiment.

FIG. 3 is a diagram illustrating a configuration of a gNB (base station) according to an embodiment.

FIG. 4 is a diagram illustrating a configuration of a protocol stack of a radio interface of a user plane handling data.

FIG. 5 is a diagram illustrating a configuration of a protocol stack of a radio interface of a control plane handling signaling (control signal).

FIG. 6 is a diagram for explaining an MRB configuration (MRB-ToAddMod) defined in the technical specifications (TS38.331) of RRC.

FIGS. 7A and 7B are diagrams illustrating an overview of operations according to an embodiment.

FIG. 8 is a diagram showing an MBS broadcast configuration (MBSBroadcastConfiguration) message in the MCCH as defined in the RRC Technical Specifications (TS38.331).

FIG. 9 is a flowchart illustrating operation pattern 1 according to an embodiment.

FIG. 10 is a flowchart illustrating operation pattern 2 according to an embodiment.

FIG. 11 is a flowchart showing operation pattern 3 according to an embodiment.

FIG. 12 is a flowchart showing operation pattern 4 according to an embodiment.

FIG. 13 is a flowchart showing operation pattern 5 according to an embodiment.

FIG. 14 is a diagram for explaining operation pattern 6 according to an embodiment.

FIG. 15 is a flowchart showing operation pattern 6 according to an embodiment.

### DESCRIPTION OF EMBODIMENTS

A mobile communication system according to an embodiment is described with reference to the drawings. In the description of the drawings, the same or similar parts are denoted by the same or similar reference signs.

### (1) Configuration of Mobile Communication System

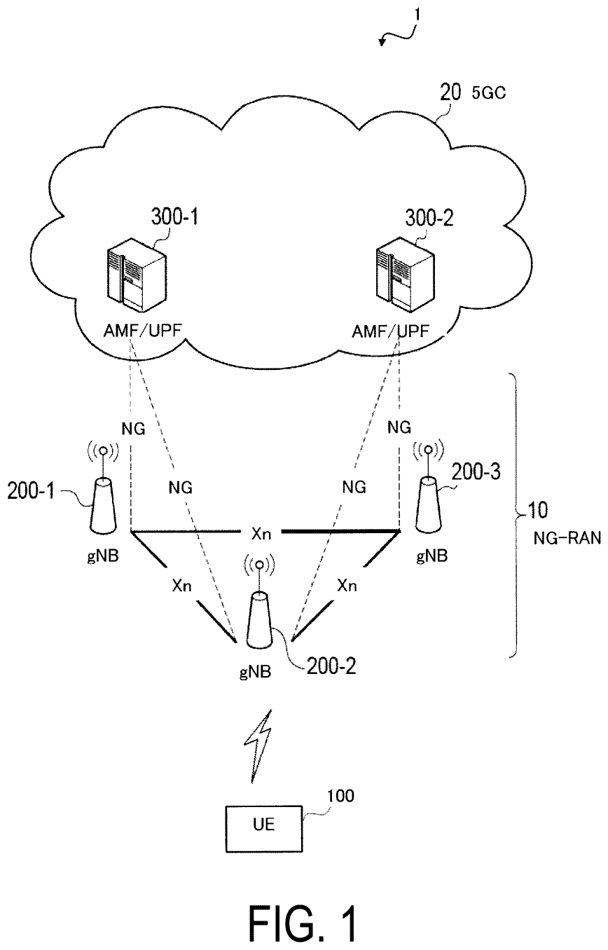

FIG. 1 is a diagram illustrating a configuration of a mobile communication system according to an embodiment. The mobile communication system 1 complies with the 5th Generation System (5GS) of the 3GPP standard. The description below takes the 5GS as an example, but Long Term Evolution (LTE) system may be at least partially applied to the mobile communication system. Alternatively, a sixth generation (6G) system may be at least partially applied to the mobile communication system.

The mobile communication system 1 includes User Equipment (UE) 100, a 5G radio access network (Next Generation Radio Access Network (NG-RAN)) 10, and a 5G Core Network (5GC) 20. The NG-RAN 10 may be hereinafter simply referred to as a RAN 10 (a network 10). The 5GC 20 may be simply referred to as a core network (CN) 20.

The UE 100 is a mobile wireless communication apparatus. The UE 100 may be any apparatus as long as the UE 100 is used by a user. Examples of the UE 100 include a mobile phone terminal (including a smartphone) and/or a tablet terminal, a notebook PC, a communication module (including a communication card or a chipset), a sensor or an apparatus provided on a sensor, a vehicle or an apparatus provided on a vehicle (vehicle UE), and a flying object or an apparatus provided on a flying object (aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter, simply referred to as a “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is an interface between a base station and the core network.

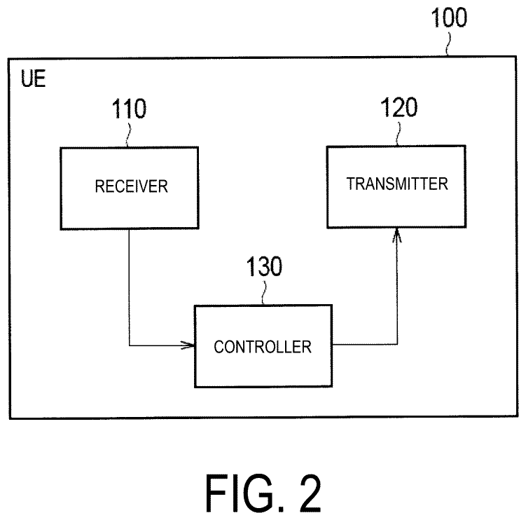

FIG. 2 is a diagram illustrating a configuration of the UE 100 (user equipment) according to an embodiment. The UE 100 includes a receiver 110, a transmitter 120, and a controller 130. The receiver 110 and the transmitter 120 constitute a wireless communicator that performs wireless communication with the gNB 200.

The receiver 110 performs various types of reception under control of the controller 130. The receiver 110 includes an antenna and a reception device. The reception device converts a radio signal received through the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various types of control and processing in the UE 100. Such processing includes processing of respective layers to be described later. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing.

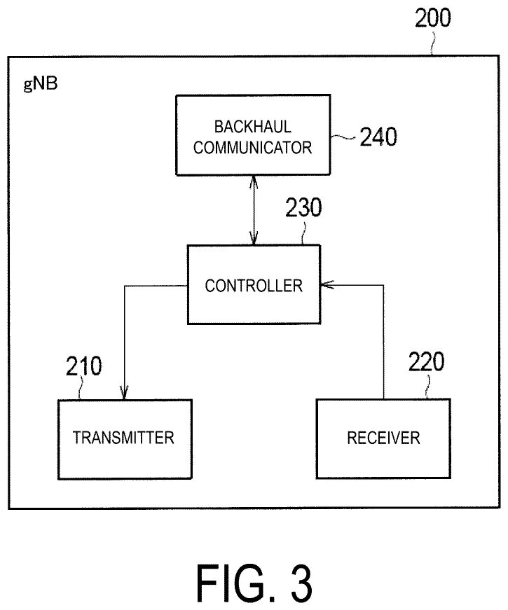

FIG. 3 is a diagram illustrating a configuration of the gNB 200 (base station) according to an embodiment. The gNB 200 includes a transmitter 210, a receiver 220, a controller 230, and a backhaul communicator 240. The transmitter 210 and the receiver 220 constitute a wireless communicator that performs wireless communication with the UE 100. The backhaul communicator 240 constitutes a network communicator that performs communication with the CN 20.

The transmitter 210 performs various types of transmission under control of the controller 230. The transmitter 210 includes an antenna and a transmission device. The transmission device converts a baseband signal (a transmission signal) output by the controller 230 into a radio signal and transmits the resulting signal through the antenna.

The receiver 220 performs various types of reception under control of the controller 230. The receiver 220 includes an antenna and a reception device. The reception device converts a radio signal received through the antenna into a baseband signal (a reception signal) and outputs the resulting signal to the controller 230.

The controller 230 performs various types of control and processing in the gNB 200. Such processing includes processing of respective layers to be described later. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 240 is connected to a neighboring base station via an Xn interface which is an inter-base station interface. The backhaul communicator 240 is connected to the AMF/UPF 300 via an NG interface between a base station and the core network. Note that the gNB 200 may include a Central Unit (CU) and a Distributed Unit (DU) (i.e., functions are divided), and both units may be connected via an F1 interface that is a fronthaul interface.

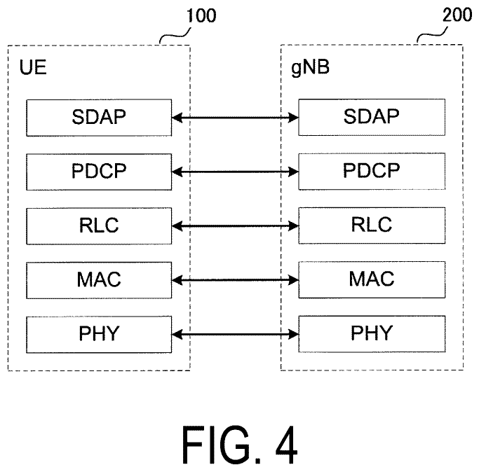

FIG. 4 is a diagram illustrating a configuration of a protocol stack of a radio interface of a user plane handling data.

A radio interface protocol of the user plane includes a PHYsical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 blind decodes the PDCCH using a radio network temporary identifier (RNTI) and acquires successfully decoded DCI as DCI addressed to the UE 100. The DCI transmitted from the gNB 200 is appended with CRC parity bits scrambled by the RNTI.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of Quality of Service (QOS) control performed by a core network and a radio bearer as the unit of QoS control performed by an Access Stratum (AS). Note that, when the RAN is connected to the EPC, the SDAP need not be provided.

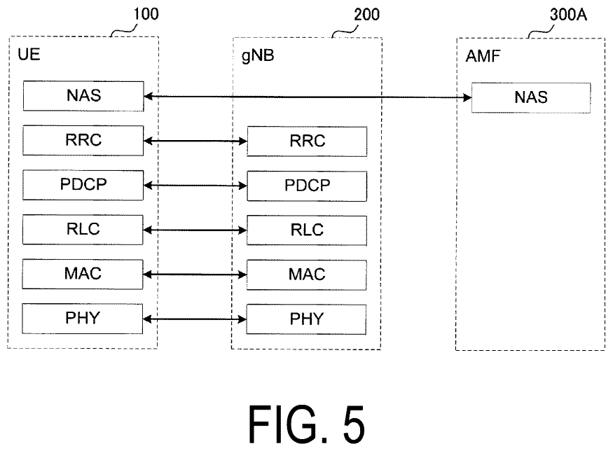

FIG. 5 is a diagram illustrating a configuration of a protocol stack of a radio interface of a control plane handling signaling (a control signal).

The protocol stack of the radio interface of the control plane includes a Radio Resource Control (RRC) layer and a Non-Access Stratum (NAS) layer instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS layer that is positioned upper than the RRC layer performs session management, mobility management, and the like. NAS signaling is transmitted between the NAS layer of the UE 100 and the NAS layer of an AMF 300A. Note that the UE 100 includes an application layer other than the protocol of the radio interface. A layer lower than the NAS layer is referred to as an AS layer.

### (2) Overview of MBS

The mobile communication system 1 can perform delivery with high resource efficiency by using the multicast/broadcast service (MBS).

In the broadcast communication services (also referred to as “MBS broadcast”), the same service and the same specific content data are provided simultaneously to every UE 100 within a geographic area. That is, every UE 100 in the broadcast service area is allowed to receive the data. The broadcast communication services are delivered to the UE 100 using a broadcast session, which is a type of MBS session. The UE 100 can receive the broadcast communication services in any state of the RRC idle state, the RRC inactive state, and the RRC connected state. Such a delivery mode is also referred to as “delivery mode 1”.

In a multicast communication service (also referred to as “MBS multicast”), the same service and the same specific content data are simultaneously provided to a specific UE set. That is, not every UE 100 in the multicast service area is allowed to receive data. The multicast communication services are delivered to the UE 100 using a multicast session, which is a type of MBS session. The UE 100 can receive the multicast communication services in the RRC connected state using mechanisms such as Point-to-Point (PTP) and/or Point-to-Multipoint (PTM) delivery. The UE 100 may receive the multicast communication services in the RRC inactive (or RRC idle) state. Such a delivery mode is also referred to as “delivery mode 2”.

Main logical channels used for MBS delivery are a multicast traffic channel (MTCH), a dedicated traffic channel (DTCH), and a multicast control channel (MCCH). The MTCH is a PTM downlink channel for transmitting MBS data of either a multicast session or a broadcast session from the network 10 to the UE 100. The DTCH is a PTP channel for transmitting MBS data of a multicast session from the network 10 to the UE 100. The MCCH is a PTM downlink channel for transmitting MBS broadcast control information associated with one or more MTCHs from the network 10 to the UE 100.

Regarding a configuration in MBS broadcast, the UE 100 in the RRC idle state, the RRC inactive state, or the RRC connected state receives an MBS configuration for a broadcast session (e.g., parameters required for MTCH reception) via the MCCH. Parameters required for reception of the MCCH (MCCH configuration) are provided through system information. In particular, system information block type 20 (SIB 20) includes the MCCH configuration. Note that SIB type 21 (SIB 21) includes information related to service continuity of MBS broadcast reception. The MCCH provides a list of all broadcast services including ongoing sessions transmitted on the MTCH, and the related information of the broadcast session includes an MBS session ID (e.g., Temporary Mobile Group Identity (TMGI)), related G-RNTI scheduling information, and information regarding neighboring cells providing a specific service on the MTCH.

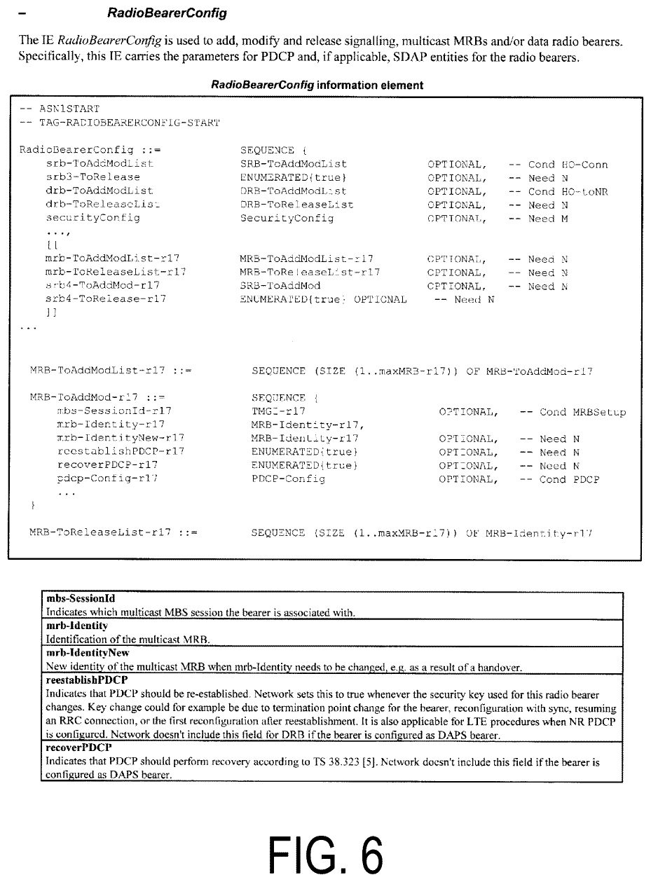

On the other hand, with respect to MBS multicast, the current technical specifications of the 3GPP enable the UE 100 to receive data of multicast sessions only in RRC connected state. When the UE 100 joining a multicast session is in the RRC connected state and the multicast session is activated, the gNB 200 transmits an RRC reconfiguration message including an MBS configuration related to the multicast session to the UE 100. Such an MBS configuration is also referred to as a multicast radio bearer (MRB) configuration, an MTCH configuration, or a multicast configuration. FIG. 6 is a diagram for explaining an MRB configuration (MRB-ToAddMod) defined in the technical specifications (TS38.331) of RRC. The MRB configuration (MRB-ToAddMod) includes an MBS session ID (mbs-SessionId), an MRB ID (mrb-Identity), and other parameters such as a PDCP configuration (pdcp-Config) for an MRB (multicast MRB) to be configured in the UE 100.

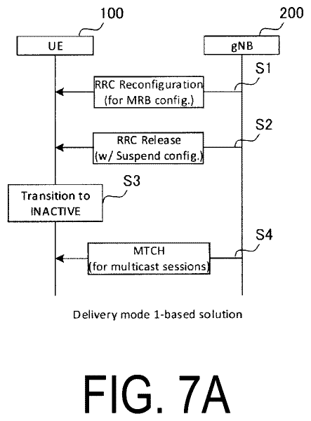

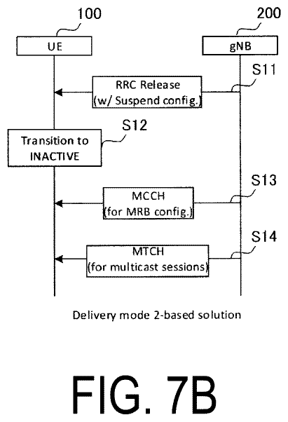

In the following embodiment, an operation of enabling the UE 100 in the RRC inactive state to perform multicast reception will be mainly described. FIGS. 7A and 7B are diagrams illustrating an overview of the operation.

As a solution for the UE 100 in the RRC inactive state to perform multicast reception, the solution based on delivery mode 1 shown in FIG. 7A and the solution based on delivery mode 2 shown in FIG. 7B are considered.

In the solution based on the delivery mode 1 shown in FIG. 7A, the gNB 200 transmits an RRC reconfiguration message including an MBS configuration related to the multicast session to the UE 100 in the RRC connected state in step S1. The UE 100 receives the multicast data on the MTCH of the multicast MRB (the multicast session) based on the RRC reconfiguration message.

In step S2, the gNB 200 transmits an RRC release (Release) message for causing the UE 100 to transition to the RRC inactive state to the UE 100 in the RRC connected state. The RRC release message includes a configuration (Suspend Config.) for the RRC inactive state.

In step S3, the UE 100 transitions to the RRC inactive (INACTIVE) state in response to the reception of the RRC release message in step S2.

In step S4, the UE 100 in the RRC inactive state continues using the MBS configuration of step S1 to receive the multicast data of the multicast MRB (the multicast sessions) on the MTCH.

This enables the UE 100 in the RRC inactive state to perform multicast reception. Note that, although an example in which the multicast configuration is performed using the RRC reconfiguration message has been described, multicast configuration may be performed using an RRC release message.

On the other hand, in the solution based on the delivery mode 2 shown in FIG. 7B, the gNB 200 transmits an RRC release message for causing the UE 100 to transition to the RRC inactive state to the UE 100 in the RRC connected state in step S11. The RRC release message includes a configuration (Suspend Config.) for the RRC inactive state.

In step S12, the UE 100 transitions to the RRC inactive (INACTIVE) state in response to the reception of the RRC release message in step S11.

In step S13, the gNB 200 transmits the MCCH including the MBS configuration for the multicast session. The UE 100 receives the MCCH.

In step S14, the UE 100 in the RRC inactive state receives the multicast data of the multicast MRB (the multicast session) on the MTCH based on the MCCH (MBS configuration) of step S13. This enables the UE 100 in the RRC inactive state to perform multicast reception.

With respect to the operation patterns of the following embodiments, improvement in the solution based on the delivery mode 2 as described above will be described.

### (3) Operation Pattern 1

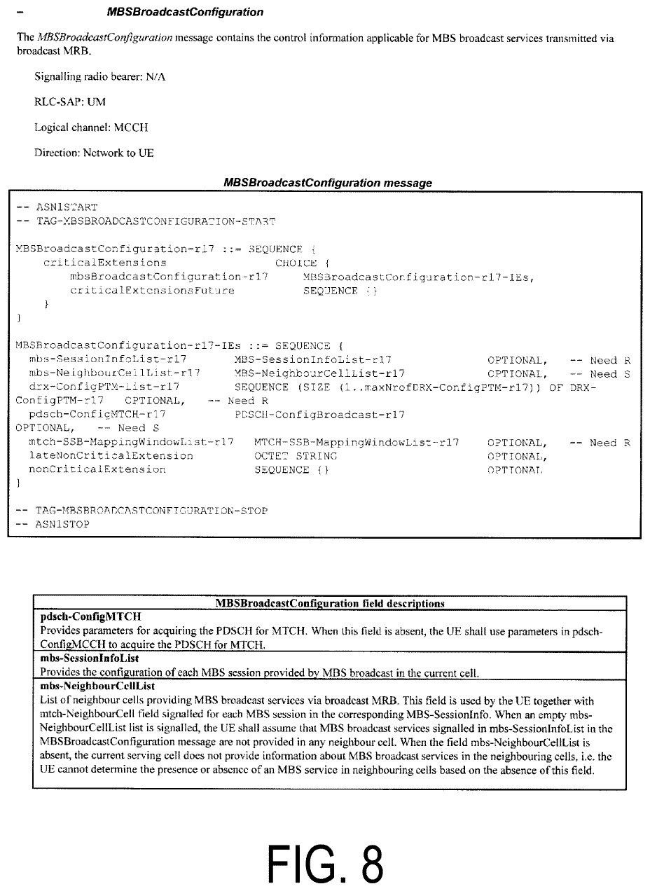

FIG. 8 is a diagram showing an MBS broadcast configuration (MBSBroadcastConfiguration) message in the MCCH as defined in the RRC Technical Specifications (TS38.331). The MCCH includes an MBS session information list (mbs-SessionInfoList) providing a configuration of each MBS session (each broadcast session) provided through MBS broadcast in a current cell, a list of neighboring cells (mbs-NeighbourCellList) providing an MBS broadcast service through a broadcast MRB, a list of DRX configurations (drx-ConfigPTM-List), and a parameter (pdsch-ConfigMTCH) for acquiring the PDSCH for the MTCH. Although the MCCH provides the broadcast configuration of broadcast sessions in the current technical specifications of the 3GPP as described above, the MCCH does not provide the multicast configuration of multicast sessions. In the present operation pattern, it is assumed that the MCCH is used to provide multicast configurations.

Only a specific UE set joining a multicast session is supposed to receive multicast communication. However, since all UEs 100 can receive the MCCH, when the network 10 (gNB 200) transmits the multicast configuration on the MCCH, all the UEs 100 can acquire the multicast configuration included in the MCCH. The present operation pattern allows only a specific of UE set joining a multicast session to acquire and apply the multicast configuration by explicitly distinguishing between the multicast configuration and the broadcast configuration in the MCCH.

In the present operation pattern, the UE 100 includes the step of receiving, from the network 10 (gNB 200), the MCCH including a plurality of MBS configurations of a plurality of MBS sessions. The plurality of MBS configurations include a broadcast configuration for a broadcast session and a multicast configuration for a multicast session. Here, in the MCCH, information indicating whether a configuration is a multicast configuration may be granted for each MBS configuration. Thus, multicast configuration and broadcast configuration can be explicitly distinguished in the MCCH.

The UE 100 acquires and applies the multicast configuration in the MCCH in response to the UE joining the multicast session. That is, only the UE 100 joining the multicast session acquires and applies the corresponding multicast configuration in the MCCH.

The UE 100 may acquire and apply the multicast configuration in response to the RRC state of the UE 100 being the RRC inactive state. That is, only the UE 100 in the RRC inactive state acquires and applies the multicast configuration in the MCCH.

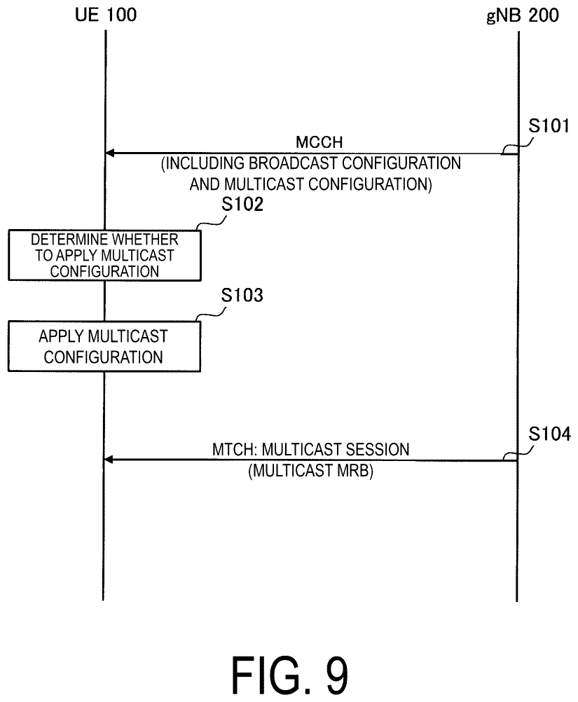

FIG. 9 is a flowchart illustrating operation pattern 1 according to an embodiment. In the description of the present operation pattern and operation patterns to be described below, overlapping description of the same operation as those shown in FIGS. 7A and 7B, particularly FIG. 7A, will not be repeated. In the present operation pattern and operation patterns to be described below, it may be assumed that the UE 100 joining a multicast session is receiving an MBS configuration (multicast configuration) related to the multicast session from the network 10 (gNB 200) through, for example, an RRC reconfiguration message. Note that, in the present operation pattern and operation patterns to be described below, it may be assumed that the UE 100 receives SIB20 prior to the reception of the MCCH.

In step S101, the gNB 200 transmits the MCCH. The UE 100 receives the MCCH. The MCCH includes configuration information of a multicast session in addition to configuration information of a broadcast session. The MCCH includes information for identifying the broadcast configuration and the multicast configuration.

For example, for each entry of the MBS session information list (mbs-SessionInfoList), the configuration may include information indicating the multicast configuration. If the information is not present, the UE 100 may determine that the corresponding configuration is a broadcast configuration. In the MCCH, the MBS session information list (MBS-SessionInfoList-Multicast-Inactive) for the multicast session (and for the RRC inactive state) may be provided separately from the MBS session information list (mbs-SessionInfoList) for the broadcast session. In the MCCH, an MBS multicast configuration (MBS Multicast Configuration) may be provided separately from the MBS broadcast configuration (MBSBroadcastConfiguration). An MBSMulticastConfiguration message may be defined separately from the MBSBroadcastConfiguration message. A new logical channel such as MCCH-multicast may be defined. Such a new message or logical channel may be transmitted in an occasion different from an existing MCCH occasion.

In step S102, the UE 100 having received the MCCH identifies the broadcast configuration and the multicast configuration included in the MCCH. The UE 100 may apply the broadcast configuration as before.

In step S103, the UE 100 determines whether to apply the multicast configuration included in the MCCH. For example, the UE 100 may determine that the multicast configuration can be applied when a first condition that the UE 100 has joined the corresponding multicast session and a second condition that the RRC state of the UE 100 is an RRC inactive state are satisfied for the multicast configuration. If these conditions are not met, the UE 100 may not be allowed to acquire and apply the multicast configuration. That is, when the UE 100 is not joining the multicast session, acquisition and application of the corresponding multicast configuration included in the MCCH are not allowed. When the RRC state of the UE 100 is the RRC idle state or the RRC connected state, acquisition and application of the multicast configuration included in the MCCH are not allowed. Note that the UE 100 may discard the multicast configuration that are not allowed to be applied.

In step S103, the UE 100 applies the multicast configuration determined to be applicable in step S102.

In step S104, the UE 100 starts receiving the multicast session based on the multicast configuration applied in step S103.

### (4) Operation Pattern 2

Differences of operation pattern 2 according to an embodiment from the operation described above will be mainly described. The present operation pattern can be implemented in combination with the above-described operations.

In the present operation pattern, the UE 100 joining a multicast session receives, first in an RRC connected state, a multicast configuration related to the multicast session in an RRC reconfiguration message from the network 10 (gNB 200). The UE 100 receives the MBS configuration (multicast configuration) for the multicast session by using the MCCH. As described above, in the present operation pattern, continuation of multicast reception in the RRC inactive state is supported by switching from delivery mode 1 to delivery mode 2.

Under such an assumption, when the UE 100 receives the MCCH (and the SIB20) after transitioning to the RRC inactive state, a problem arises that it takes time to resume multicast reception. In the present operation pattern, interruption of multicast reception can be reduced by providing information (multicast configuration) in the MCCH by using an RRC release message for causing the UE 100 to transition to the RRC inactive state.

In other words, in the present operation pattern, the UE 100 receives the RRC release message for causing the UE 100 to transition to the RRC inactive state from the network 10 (gNB 200). The RRC release message includes the MBS configuration (multicast configuration) provided by the network 10 (gNB 200) on the MCCH.

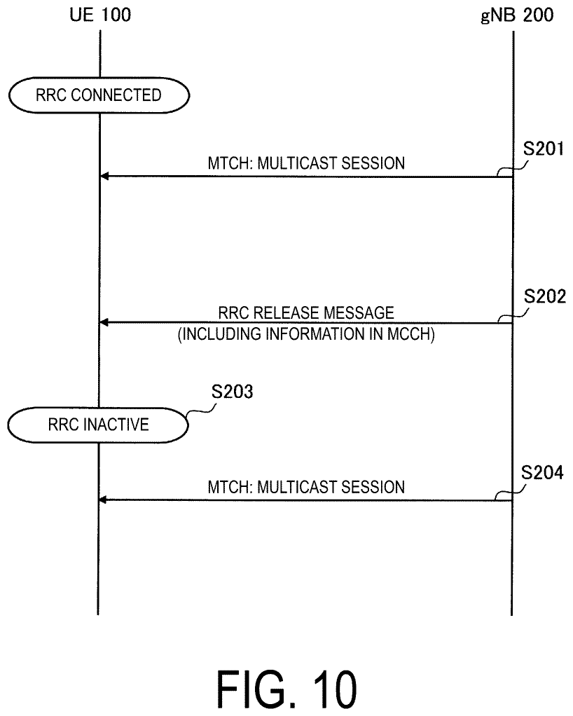

FIG. 10 is a diagram illustrating the operation pattern 2 according to an embodiment.

In step S201, the UE 100 in the RRC connected state performs multicast reception.

In step S202, the gNB 200 determines to cause the UE 100 to transition to the RRC inactive state and transmits an RRC release message to the UE 100. The UE 100 receives the RRC release message. The RRC release message may include mbsBroadcastConfiguration shown in FIG. 8. Specifically, the RRC release message includes MBS-SessionInfo (scheduling information of the MTCH). The gNB 200 may include, in the RRC release message, only the MCCH information for the multicast session that the UE 100 is receiving. The gNB 200 may include, in the RRC release message, drx-ConfigPTM-List (DRX configuration list of MTCH), pdsch-ConfigMTCH (PDSCH configuration of MTCH), and mtch-SSB-MappingWindowList (mapping configuration list of MTCH and SSB) as additional information. The gNB 200 may include the SIB20 for receiving the MCCH in the RRC release message.

In step S203, the UE 100 transitions to the RRC inactive state in response to the reception of the RRC release message in step S202.

In step S204, the UE 100 in the RRC inactive state applies the multicast configuration corresponding to the multicast session included in the information received in step S202, the multicast session being currently received, and starts receiving the multicast session.

### (5) Operation Pattern 3

Differences of operation pattern 3 according to an embodiment from the operations described above will be mainly described. The present operation pattern can be implemented in combination with the above-described operations.

The UE 100 that performs multicast reception in the RRC connected state can perform multicast reception using the multicast configuration provided in the RRC reconfiguration message, and does not need to receive the MCCH. Here, when it is not assumed that the MCCH information is provided by dedicated signaling as in the above-described operation pattern 2, explicit instruction from the gNB 200 to receive the MCCH is preferable. The gNB 200 desirably causes the UE 100 to transition to the RRC inactive state after confirming that the UE 100 has started multicast reception in delivery mode 2. Therefore, it is assumed that the UE 100 give feedback to the gNB 200.

In the present operation pattern, the UE 100 that receives the multicast session from the network 10 (gNB 200) in the RRC connected state receives the reception instruction for the MCCH from the network 10 (gNB 200). In response to the reception instruction, the UE 100 receives the MCCH and attempts to receive the multicast session. The UE 100 transmits, to the network 10 (gNB 200), information indicating the multicast session that the UE 100 successfully or unsuccessfully received.

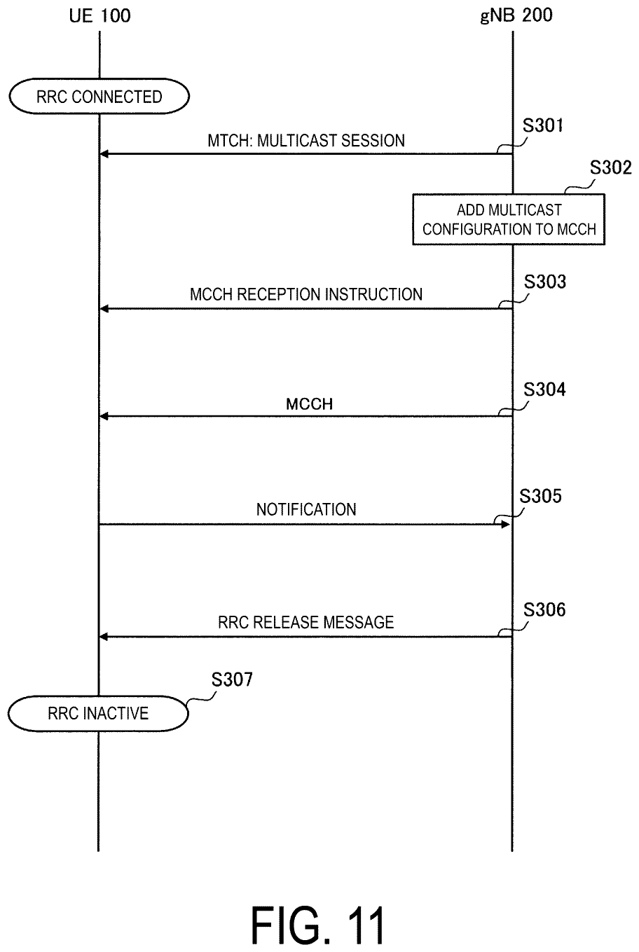

FIG. 11 is a flowchart showing operation pattern 3 according to an embodiment.

In step S301, the UE 100 in the RRC connected state performs multicast reception.

In step S302, upon determining to cause the UE 100 in the RRC connected state during multicast reception to transition to the RRC inactive state, the gNB 200 adds the configuration information related to the multicast session that the UE 100 is receiving to the MCCH. However, the gNB 200 may also add configuration information of all multicast sessions currently being provided to the MCCH.

In step S303, the gNB 200 instructs the UE 100 to receive the MCCH. The instruction may be an instruction to receive the multicast session in delivery mode 2. The instruction may be an instruction to receive the MTCH corresponding to the MCCH (configured by the MCCH). The instruction may be an indication to receive the SIB20. The instruction may include the multicast session ID (TMGI, or MRB ID) of the multicast session to be received in delivery mode 2. The gNB 200 may not schedule unicast communication in the slot corresponding to SIB20/MCCH/MTCH.

In step S304, the UE 100 performs the following processing on the multicast session being received in response to reception of the instruction of step S303.
SIB20 may be received (the configuration content of SIB20 may be applied).
To receive the MCCH (to apply the configuration content of the MCCH)
Reception of the MTCH may be started.

In step S305, the UE 100 notifies the gNB 200 that reception of the multicast session can be started in delivery mode 2.

The UE 100 may transmit the notification when the UE 100 is triggered by the normal reception of the MCCH, the application of the configuration content of the MCCH, or the start of reception of the MTCH. The UE 100 may transmit the notification in a UE assistance information (Assistance Information) message. The UE assistance information message may include an information element (Preferred RRC state=inactive) indicating that the RRC state desired by the UE 100 is the RRC inactive state. The UE 100 may transmit the notification in an MBS interest indication (Interest Indication) message. The UE 100 may transmit the notification in a response message to the instruction of step S303. The notification may include information indicating that the UE 100 was able to start receiving the multicast session (for example, information indicating that the MCCH has been received or reception of the MTCH has been started). This notification may include a multicast session ID (TMGI, MRB ID, etc.) that the UE 100 can start receiving.

In step S305, the UE 100 may notify the gNB 200 that the UE 100 was not able to start receiving the multicast session (for example, that the MCCH cannot be received or that the MTCH cannot be received). The UE 100 may perform the notification when the UE 100 was not able to start receiving the multicast session in a predetermined period of time after receiving the instruction of the step S303. The predetermined period of time may be set by the gNB 200, or may be a value predefined in the technical specifications. The UE 100 may include the multicast session ID (TMGI, MRB ID, etc.) that the UE 100 was not able to start receiving in the notification. The gNB 200 suspends (stops) transition to the RRC inactive state for the UE 100 that is not able to start multicast reception, or configures the MCCH with the RRC release message (see the above-described operation pattern 2).

In step S306, the gNB 200 transmits an RRC release message to the UE 100 after confirming that the UE 100 has started receiving the multicast session.

In step S307, the UE 100 transitions to the RRC inactive state in response to the reception of the RRC release message. The UE 100 in the RRC inactive state performs multicast reception using the multicast configuration received on the MCCH.

### (6) Operation Pattern 4

Differences of operation pattern 4 according to an embodiment from the operations described above will be mainly described. The present operation pattern can be implemented in combination with the above-described operations.

In the present operation pattern, the UE 100 in the RRC connected state receives a multicast session from the network 10 (gNB 200) using the MBS configuration (multicast configuration for the RRC connected state) of the multicast session. The UE 100 transitions to the RRC inactive state and attempts to receive the MCCH. The UE 100 continues receiving the multicast session by using the MBS configuration (multicast configuration for the RRC connected state) until the UE 100 receives the MCCH. Thus, service disconnection of multicast reception can be reduced.

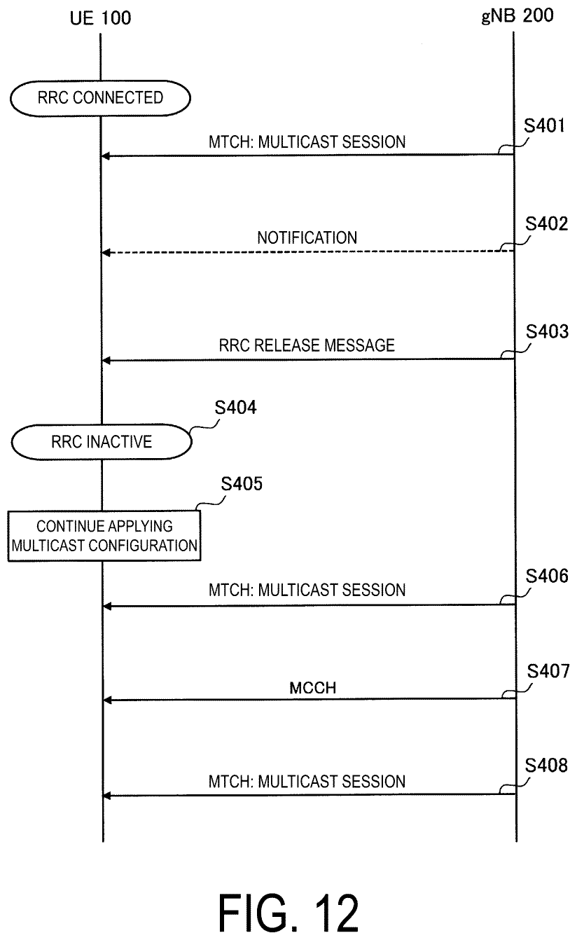

FIG. 12 is a flowchart showing operation pattern 4 according to an embodiment.

In step S401, the UE 100 in the RRC connected state performs multicast reception.

In step S402, the gNB 200 may notify the UE 100 that the application of the multicast configuration in the RRC connected state may be continued until the MCCH reception is completed after a transition to the RRC inactive state.

In step S403, the gNB 200 transmits an RRC release message to the UE 100.

In step S404, the UE 100 transitions to the RRC inactive state in response to the reception of the RRC release message.

In step S405, the UE 100 in the RRC inactive state continuously applies the multicast configuration received in the RRC connected state. Thus, the UE 100 performs multicast reception (step S406).

In step S407, the UE 100 in the RRC inactive state attempts to acquire the MCCH. When the reception of the MCCH is successful or when the MCCH configuration is applied, the UE 100 performs multicast reception using the multicast configuration of the MCCH (step S408). In this case, the UE 100 may discard the multicast configuration received in the RRC connected state.

### (7) Operation Pattern 5

Differences of operation pattern 5 according to an embodiment from the operations described above will be mainly described. The present operation pattern can be implemented in combination with the above-described operations.

In the present operation pattern, switching from delivery mode 2 to delivery mode 1 will be described. Multicast reception in the RRC inactive state may be required if the gNB 200 fails to cause the UE 100 to maintain the RRC connected state due to network congestion. For this reason, multicast reception in the RRC inactive state is considered to be temporary. After the network congestion is resolved, the gNB 200 may cause all the UEs 100 performing multicast reception in the RRC inactive state to return to the RRC connected state to perform multicast reception. Therefore, service interruption is desirably reduced also during switching from delivery mode 2 to delivery mode 1.

In the present operation pattern, the UE 100 in the RRC inactive state receives a multicast session from the network 10 (gNB 200) using a first MBS configuration (first multicast configuration) provided by the MCCH. Upon transitioning to the RRC connected state, the UE 100 receives an RRC reconfiguration message including a second MBS configuration (second multicast configuration) from the network 10 (gNB 200). The UE 100 in the RRC connected state discards the first MBS configuration (first multicast configuration) in response to the transition to the RRC connected state or the reception of the RRC reconfiguration message.

For example, upon receiving the multicast configuration (delivery mode 1) in the RRC reconfiguration message, the UE 100 discards the multicast configuration (delivery mode 2) configured by the MCCH. When the UE 100 starts (has started) reception of the MTCH according to the multicast configuration of the RRC reconfiguration message, the UE 100 may stop the reception of the MTCH according to the multicast configuration of the MCCH.

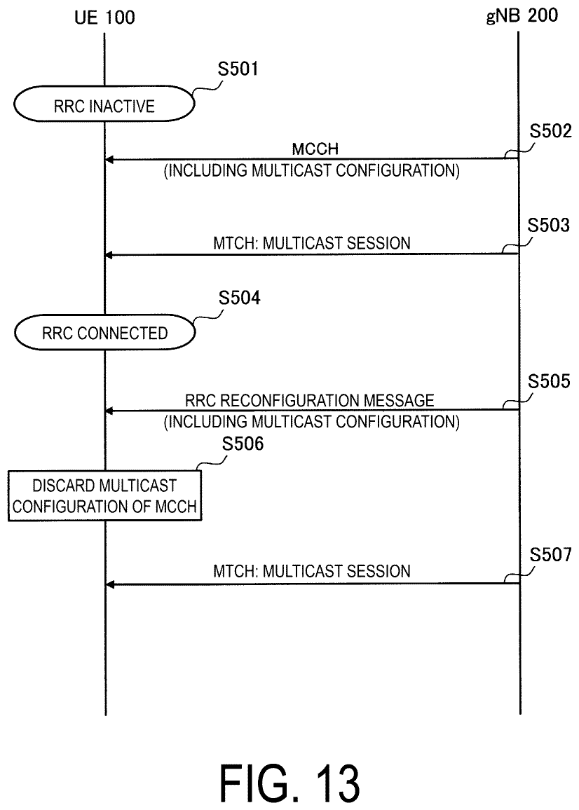

FIG. 13 is a flowchart showing operation pattern 5 according to an embodiment.

In step S502, the UE 100 in the RRC inactive state receives, from the gNB 200, the MCCH including multicast configuration. The MCCH may be provided in an RRC release message.

In step S503, the UE 100 in the RRC inactive state performs multicast reception using the multicast configuration of step S502.

In step S504, the UE 100 transitions to the RRC connected state. For example, the UE 100 may transmit an RRC resume request (Resume Request) message to the gNB 200 upon receiving a call from the gNB 200 through RAN paging. Upon transitioning to the RRC connected state, the UE 100 may stop the multicast reception of step S503. For example, the UE 100 may stop the MCCH reception processing. The UE 100 may discard the content (multicast configuration) configured in the MCCH. The UE 100 may stop the MTCH (multicast session) reception processing configured in the MCCH.

In step S505, the gNB 200 transmits an RRC reconfiguration message including the multicast configuration to the UE 100. The UE 100 receives the RRC reconfiguration message. In step S506, the UE 100 may stop the multicast reception of step S503 in response to the reception of the multicast configuration of step S505. For example, the UE 100 may stop the MCCH reception processing. The UE 100 may discard the content (multicast configuration) configured in the MCCH. The UE 100 may stop the MTCH (multicast session) reception processing configured in the MCCH.

In step S507, the UE 100 in the RRC connected state performs multicast reception using the multicast configuration of step S505.

### (8) Operation Pattern 6

Differences of operation pattern 6 according to an embodiment from the operations described above will be mainly described. The present operation pattern can be implemented in combination with the above-described operations. The present operation pattern is an operation pattern focusing on cell reselection performed after the UE 100 transitions to the RRC inactive state.

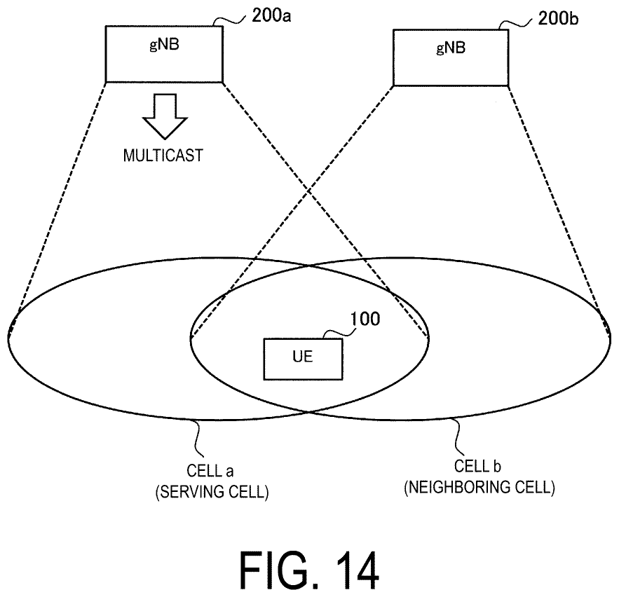

FIG. 14 is a diagram for explaining operation pattern 6 according to an embodiment. In the illustrated example, a gNB 200a manages a cell a and a gNB 200b manages a cell b. The UE 100 in the RRC inactive state performs multicast reception in the cell a (gNB 200a) in the RRC inactive state using the multicast configuration included in the MCCH received in the cell a (gNB 200a). When the UE 100 leaves the cell a and moves out of range, the UE 100 transitions from the RRC inactive state to the RRC idle state. Under such an assumption, the UE 100 may discard the multicast configuration in response to the transition from the RRC inactive state to the RRC idle state.

As described above, the UE 100 in the RRC inactive state receives a multicast session from the network 10 (gNB 200) using an MBS configuration (multicast configuration) provided on the MCCH. The UE 100 discards the MBS configuration (multicast configuration) in response to the transition to the RRC idle state.

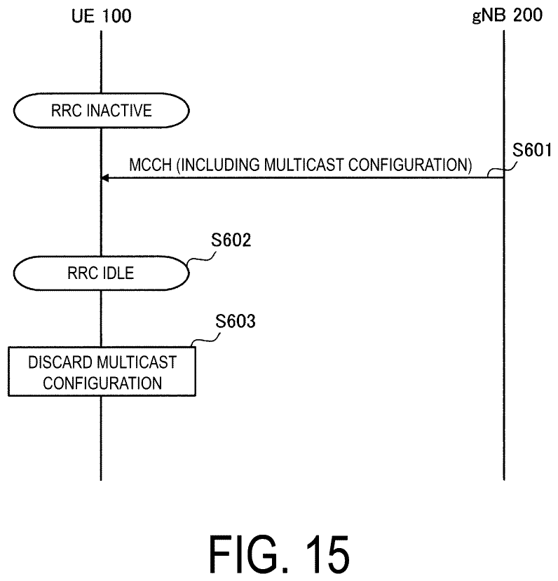

FIG. 15 is a flowchart showing the operation pattern 6 according to an embodiment.

In step S601, the UE 100 in the RRC inactive state performs multicast reception using the multicast configuration provided on the MCCH. The MCCH may be provided in an RRC release message.

In step S602, the UE 100 in the RRC inactive state transitions to the RRC idle state. For example, the UE 100 transitions to the RRC idle state by moving out of range.

In step S603, in response to the transition to the RRC idle state, the UE 100 discards the applied multicast configuration and stops the multicast reception (MTCH reception).

### (9) Other Embodiment

Although the multicast reception in the RRC inactive state has been mainly described in the above-described embodiments, the operations according to the above-described embodiments may also be applied to multicast reception in the RRC idle state. With respect to the RRC idle state, the above-described RRC resume (Resume) can be read as RRC establishment (Establishment).

The operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps may not be necessarily performed, and only some of the steps may be performed.

Although the example in which the base station is an NR base station (gNB) has been described in the embodiments and examples described above, the base station may be an LTE base station (eNB) or a 6G base station. The base station may be a relay node such as an Integrated Access and Backhaul (IAB) node. The base station may be a DU of the IAB node. The UE 100 may be a mobile termination (MT) of the IAB node.

A program causing a computer to execute each of the processing performed by the UE 100 or the gNB 200 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM. Circuits for executing processing performed by the UE 100 or the gNB 200 may be integrated, and at least a part of the UE 100 and the gNB 200 may be implemented as a semiconductor integrated circuit (chipset, System on a chip (SoC)).

The phrases “based on” and “depending on/in response to” used in the present disclosure do not mean “based only on” and “only depending on/in response to” unless specifically stated otherwise. The phrase “based on” means both “based only on” and “based at least in part on”. The phrase “depending on” means both “only depending on” and “at least partially depending on”. The terms “include,” “comprise” and variations thereof do not mean “include only items stated” but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

Embodiments have been described above in detail with reference to the drawings, but specific configurations are not limited to those described above, and various design variation can be made without departing from the gist of the present disclosure.

### (10) First Supplementary Note

Features relating to the embodiments described above are described below as supplements.

### Supplementary Note 1

A communication method used in a mobile communication system that provides a multicast/broadcast service (MBS), the communication method including receiving, by a user equipment, a multicast control channel (MCCH) from a network, the MCCH including a plurality of MBS configurations of a plurality of MBS sessions, in which the plurality of MBS configurations include a broadcast configuration for a broadcast session and a multicast configuration for a multicast session.

### Supplementary Note 2

The communication method described in supplementary note 1, further including acquiring and applying, by the user equipment, the multicast configuration in the MCCH in response to the user equipment joining the multicast session.

### Supplementary Note 3

The communication method described in supplementary note 1 or 2, further including acquiring and applying, by the user equipment, the multicast configuration in response to an RRC state of the user equipment being an RRC inactive state.

### Supplementary Note 4

A communication method used in a mobile communication system that provides a multicast/broadcast service (MBS), the communication method including the steps of: receiving, by a user equipment in a radio resource control (RRC) connected state, a multicast session from a network; and
receiving, by the user equipment from the network, an RRC release message for causing the user equipment to transition to an RRC inactive state,
in which the RRC release message includes an MBS configuration provided by the network on a multicast control channel (MCCH).

### Supplementary Note 5

A communication method used in a mobile communication system that provides a multicast/broadcast service (MBS), the communication method including the steps of: receiving, by a user equipment in a radio resource control (RRC) connected state, a multicast session from a network;
receiving, by the user equipment, a reception instruction for a multicast control channel (MCCH) from the network;
attempting, by the user equipment, to receive the multicast session by receiving the MCCH in response to the reception instruction; and
transmitting, by the user equipment to the network, information indicating the multicast session successfully or unsuccessfully received.

### Supplementary Note 6

A communication method used in a mobile communication system that provides a multicast/broadcast service (MBS), the communication method including the steps of:
receiving, by a user equipment in a radio resource control (RRC) connected state, a multicast session from a network by using an MBS configuration of the multicast session;
transitioning the user equipment to an RRC inactive state;
attempting, by the user equipment in the RRC inactive state, to receive a multicast control channel (MCCH); and
continuing, by the user equipment in the RRC inactive state, receiving the multicast session by using the MBS configuration until the user equipment receives the MCCH.

### Supplementary Note 7

A communication method used in a mobile communication system that provides a multicast/broadcast service (MBS), the communication method including the steps of:
receiving, by a user equipment in a radio resource control (RRC) inactive state, a multicast session from a network by using a first MBS configuration provided on a multicast control channel (MCCH);
transitioning the user equipment to an RRC connected state;
receiving, by the user equipment in the RRC connected state, an RRC reconfiguration message including a second MBS configuration from the network; and
discarding, by the user equipment in the RRC connected state, the first MBS configuration in response to the transition to the RRC connected state or the reception of the RRC reconfiguration message.

### Supplementary Note 8

A communication method used in a mobile communication system that provides a multicast/broadcast service (MBS), the communication method including the steps of:
receiving, by a user equipment in a radio resource control (RRC) inactive state, a multicast session from a network by using an MBS configuration provided on a multicast control channel (MCCH);
transitioning the user equipment to an RRC idle state; and
discarding, by the user equipment, the MBS configuration in response to the transition to the RRC idle state.

### (11) Second Supplementary Note

### Introduction

At RAN #94e, a new work item was approved for MBS enhancement (eMBS) with a revised WID at RAN #96. One purpose of Release 18 is to allow UEs in the RRC inactive state to receive multicast sessions.
To define support for multicast reception by UEs in the RRC inactive state.
To configure PTM of a UE receiving multicast in the RRC inactive state
To investigate the impact of mobility and state transition of the UE receiving multicast in the RRC inactive state (seamless/lossless mobility is not a requirement).

In this supplementary note, the support for multicast reception in the RRC inactive state will be discussed first, taking into account the relevant discussion made in Release 17.

### Discussion

### Discussion in Release 17 and Directionality of Solutions in Release 18

Although multicast reception in the RRC inactive state has been briefly discussed in Release 17, RAN2 decided to prioritize multicast reception only in the RRC connected state as follows. Although RAN2 did not define this function in Release 17, there are already some potential solutions, which are still good starting points for discussion of Release 18.

Chairman: RAN2 prioritizes active multicast support in the RRC connected mode in Release 17. If time permits, support for multicast in the RRC inactive state can be discussed later (when the solution for multicast and solution for broadcast in the connected mode become more mature).

The network may release a UE receiving a multicast session to be inactive, such as when the network becomes congested due to a large number of UEs in the cell. Thus, in this scenario, it is assumed that the UE is initially connected when the UE starts receiving the multicast session (including the procedure of joining the multicast session). Then, the UE is released to be inactive while continuing reception of the multicast session.

Observation 1: This scenario is that a UE receiving a multicast session in the RRC connected state is released to the RRC inactive state so that the UE can continue receiving the multicast session.

In Release 17, two delivery modes are defined, which are referred to as “delivery mode 1” for multicast sessions and “delivery mode 2” for broadcast sessions. Although the reception configuration of the MTCH is provided to the UE in the connected state through the RRC reconfiguration in the delivery mode 1, in the delivery mode 2, the reception configuration is provided to all the UEs in the RRC state through the MCCH.

In order to support multicast reception in the inactive state, whether the solution is based on “delivery mode 1” or “delivery mode 2” needs to be considered first.

Although providing multicast sessions is simple in delivery mode 1, the mode is currently limited to UEs in the connected state. In order to support UEs in the inactive state, many functions and assumption restrictions/changes, such as handling of the MTCH configuration, deactivation of PTP legs, HARQ feedback, CFR, etc., may be needed. Although RAN1 may need to be involved in those changes, note that RAN1 is not described in Rel-18eMBSWI.

Observation 2: In order to provide a multicast session, providing the reception configuration of the MTCH through dedicated signaling is direct (i.e. based on delivery mode 1). However, note that RAN1 involvement may be required, which the WG to be supported by the WID does not include.

Although delivery mode 2 already supports broadcast reception in the inactive state, the mode is less likely to be able to control a network (NW) than in a multicast session. The MCCH is likely to be received by all UEs and the reception configuration of the MTCH associated with multicast sessions is also visible to all the UEs, and thus potential security concerns exist.

Observation 3: The MCCH can provide a broadcast session for UEs that are already in the RRC inactive state (i.e. based on delivery mode 2). However, Release 17 has a problem of less control over networks.

From the above observations, since RAN 2 supports multicast reception in the RRC inactive state, the direction of the solution with respect to whether the reception configuration of the MTCH is provided through dedicated signaling (i.e., delivery mode 1-based solution) or provided by the MCCH (i.e., delivery mode 2-based solution) needs to be discussed.

Proposal 1: Since RAN 2 supports multicast reception in the RRC inactive state, the direction of the solution with respect to whether the reception configuration of the MTCH is provided through dedicated signaling (i.e., delivery mode 1-based solution) or provided by the MCCH (i.e., delivery mode 2-based solution) needs to be discussed.

### Delivery Mode 1—Based Solution

When the reception configuration of the MTCH is provided through dedicated signaling, whether the configuration is provided by RRC reconfiguration (same as or similar to Release 17) or provided by RRC release needs to be discussed.

Using RRC reconfiguration, the UE continues applying the same configuration to receive the MTCH of interest even if the UE transitions from the connected state to the inactive state. The advantage is that the current RRC reconfiguration can be reused since the MRB configuration is already defined in Release 17. On the other hand, since the UE needs to continue applying the MRB configuration even after transitioning to the inactive state, additional UE behavior needs to be defined in the RRC reconfiguration procedure. In this case, the question remains, such as whether the UE that is interested in the multicast session and has transitioned to the inactive state can continue applying the configuration at all times, or whether the network needs to explicitly indicate whether to apply the MRB configuration by RRC release, or the like. RAN2 needs to discuss whether the UE can verify the MRB configuration, in other words, whether a validity timer like T320 of dedicated priority is needed. In RRC release, when the UE transitions to the inactive state, the UE can continue receiving the MTCH of interest by simply applying a new configuration if the RRC release message has provided the configuration. In general, when the UE transitions to the RRC inactive state, it is very simple to use RRC release to provide a specific configuration to the UE. When the affinity with the RNA update procedure is high and the MRB used in the inactive state can be reconfigured even in the RNA update (i.e., RRC release), the UE can be reconfigured without transitioning to the connected state. However, a disadvantage is that signaling overhead always occurs. That is, the MRB configuration occurs even though the configuration is the same as that already provided through the RRC reconfiguration in advance. It is also worth discussing whether a validity timer is required.

Therefore, when the configuration of the received MTCH is provided through dedicated signaling, RAN2 needs to discuss whether the configuration is provided through RRC reconfiguration or RRC release. RAN2 needs to also discuss whether a validity timer is required for such a dedicated configuration.

Proposal 2: For the delivery mode 1-based solution, RAN2 needs to discuss whether the configuration of the received MTCH is provided through RRC reconfiguration or RRC release.

Proposal 3: For the delivery mode 1-based solution, RAN2 needs to discuss whether the configuration for the UE to receive the MTCH can always be considered valid or is valid only during a certain period of time (e.g., using a validity timer).

Another issue to consider is the impact of UE mobility under the assumption that “seamless/lossless mobility is not needed” as described in the WID. In Release 17, it is clear that the configuration for receiving the MTCH in delivery mode 1 is valid only within the cell in which the UE is configured. When handover is performed, the target cell reconfigures the UE to a new configuration. On the other hand, when the UE in the inactive state performs mobility in the idle mode, it may be considered as the starting point when the existing configuration for receiving the MTCH is no longer valid within the reselected cell (i.e., a new cell).

In order for the UE to be handed over from a serving cell to a target cell or reconfigured by a reselected cell, requesting a transition of the UE that is always inactive to a connected state (e.g., before or after performing cell reselection) may be the simplest solution with minimal impact on the specification.

Since the configuration for MTCH reception is valid in the RNA, the gNB needs to be able to apply the same configuration in the RNA of each UE. An advantage of this method is that the UE in the inactive state does not need to be reconfigured and can continue receiving the MTCH in the RNA. On the other hand, the RNA is UE-specific, which leads to increased network complexity.

A more flexible and less complex method may be that the gNB provides a cell list in the configuration and that the configuration is considered valid in the cells included in the list. The cell list can be configured to be either cell-specific, UE-specific, RNA-related, MRB area-specific, or MBS service area-specific, depending on implementation of a NW.

Therefore, the RAN2 needs to discuss whether to introduce the area scope of such configurations.

Proposal 4: For the delivery mode 1-based solution, the RAN2 needs to discuss whether the reception configuration of the MTCH is valid within the serving cell or valid within the area (such as the RNA or cell list).

### Delivery Mode 2—Based Solution

As described above, when the configuration for receiving the MTCH is provided on the MTCH, all configurations, i.e., the MBS session information, can be seen by all UEs, even if some UEs are not joining the multicast session. Therefore, those UEs not joining the multicast session need not to be able to receive the multicast MTCH.

Although the upper layer procedure assumes that the UE cannot receive the MTCH for TMGI of the multicast session within the USD, it is up to the gNB's decision on whether to use delivery mode 1 or delivery mode 2 for delivery of the multicast session. Therefore, the solution to the AS layer is desirable. One of the simplest solutions is to set an indicator in each piece of MBS session information of the MCCH to distinguish between a multicast session and a broadcast session. UEs not joining a multicast session are not able to use the corresponding MTCH. RAN2 needs to discuss whether it is a problem to be solved when the MCCH is used for multicast reception in the inactive state.

Proposal 5: For the delivery mode 2-based solution, RAN2 needs to consider whether a UE needs to be not allowed to use a multicast MTCH if the UE is not joining the corresponding multicast session.

Another problem worth considering is the process of switching from delivery mode 1 to delivery mode 2 while receiving a multicast session. Although WID states “seamless/lossless mobility is not required”, some degree of service continuity needs to be ensured as part of the service requirements and expectations of the multicast session.

When the UE starts to acquire the MCCH and the MTCH after an RRC state transition shortly after being released to be inactive, a service interruption at the time of switch of the delivery mode may be possibly excessive. For this reason, such a service interruption needs to be minimized although the service is not seamless/lossless.

A possible solution is that the gNB provides the MCCH to the UE through a dedicated signal while the UE is still connected. In this method, service interruptions can be reduced because the UE can start receiving the MTCH before transitioning to the inactive state. One question is whether the dedicated signaling is an RRC reconfiguration or RRC release, so if the dedicated signaling is the RRC reconfiguration, the UE is considered to be able to start reception of the MTCH early.

Proposition 6: For the delivery mode 2-based solution, RAN2 needs to discuss whether service interruptions need to be minimized when switching from delivery mode 1 to delivery mode 2.

Proposal 7: If the proposal 6 can be agreed, RAN2 needs to further discuss whether to provide the MCCH through dedicated signaling. Whether dedicated signaling is an RRC reconfiguration or RRC release needs to be further studied.

### REFERENCE SIGNS

1: Mobile communication system
10: RAN
20: CN
100: User equipment (UE)
110: Receiver
120: Transmitter
130: Controller
200: gNB (Base station)
210: Transmitter
220: Receiver
230: Controller
240: Backhaul communicator

1. A communication method used in a mobile communication system configured to provide a multicast/broadcast service (MBS), the communication method comprising
transmitting, by a network node, a multicast control channel (MCCH) comprising a plurality of MBS configurations of a plurality of MBS sessions, the plurality of MBS configurations comprising a multicast configuration for a multicast session; and
acquiring and applying, by the user equipment, the multicast configuration in the MCCH in response to the user equipment joining the multicast session.

2. The communication method according to claim 1, further comprising
acquiring and applying, by the user equipment, the multicast configuration in response to an RRC state of the user equipment being an RRC inactive state.

3. A user equipment in a mobile communication system configured to provide a multicast/broadcast service (MBS), the user equipment comprising:
a receiver configured to receive from a network node, a multicast control channel (MCCH) comprising a plurality of MBS configurations of a plurality of MBS sessions, the plurality of MBS configurations comprising a multicast configuration for a multicast session, and
a controller configured to acquire and apply the multicast configuration in the MCCH in response to the user equipment joining the multicast session.

4. A chipset for a user equipment in a mobile communication system configured to provide a multicast/broadcast service (MBS), the chipset configured to execute processes of:
receiving from a network node, a multicast control channel (MCCH) comprising a plurality of MBS configurations of a plurality of MBS sessions, the plurality of MBS configurations comprising a multicast configuration for a multicast session; and
acquiring and applying the multicast configuration in the MCCH in response to the user equipment joining the multicast session.

5. A non-transitory computer-readable medium comprising, stored thereupon, computer program instructions for execution by a user equipment in a mobile communication system configured to provide a multicast/broadcast service (MBS), the program instructions being configured to cause the user equipment to execute processes of:
receiving from a network node, a multicast control channel (MCCH) comprising a plurality of MBS configurations of a plurality of MBS sessions, the plurality of MBS configurations comprising a multicast configuration for a multicast session; and
acquiring and applying the multicast configuration in the MCCH in response to the user equipment joining the multicast session.

6. A mobile communication system configured to provide a multicast/broadcast service (MBS), the mobile communication system comprising a network node and a user equipment, wherein
the network node is configured to transmit a multicast control channel (MCCH) comprising a plurality of MBS configurations of a plurality of MBS sessions, the plurality of MBS configurations comprising a multicast configuration for a multicast session, and
the user equipment is configured to acquire and apply the multicast configuration in the MCCH in response to the user equipment joining the multicast session.
